(19) United States
(12) Patent Application Publication
(10) Pub. No.: US 2004/0027109 A1
(43) Pub. Date: Feb. 12, 2004

(54) Apparatus and method for electric current control

(76) Inventor: Chung-Cheng Chen, Hsinchu (TW)

Correspondence Address: Mr. Joseph A. Sawyer, Jr., SAWYER LAW GROUP LLP, Embarcadero Corporate Road, Suite 406, 2465 East Bayshore Road, Palo Alto, CA, 94303, US

(21) Appl. No.: 10/623,377

(22) Filed: Jul. 18, 2003

(30) Foreign Application Priority Data
Aug. 8, 2002 (TW) 091117851

(51) Int. Cl. G05F 1/40

(52) U.S. Cl. 323/283

(57) ABSTRACT

An apparatus and a method for electric current control are provided. The electric current control apparatus is connected with a first electronic device and a second electronic device. Under a condition not having additional power supply, the electric current control apparatus can rectify and amplify an electric current of a finite current source from the first electronic device, and output the rectified and amplified electric current to the second electronic device. Further, the electric current control apparatus can charge up a charger module thereof with the electric current of the finite current source and combine an electric current from the charger module after being charged with the electric current of the finite current source, and then provide the combined electric current for the second electronic device for usage.

### FIELD OF THE INVENTION

The present invention relates to apparatuses and methods for electric current control, and more particularly, to an electric current control apparatus provided between two electronic devices, without using additional power supply, for rectifying, amplifying and outputting an electric current from a finite current source and for regulating and filtering a rated electric current from the finite current source, and an electric current control method for use with the electric current control apparatus.

### BACKGROUND OF THE INVENTION

The common electronic devices, such as personal computers and notebooks, are usually equipped with a plurality of output transmission interfaces, e.g. USB (universal serial bus), PCMCIA (Personal Computer Memory Card International Association), IEEE (Institute of Electrical and Electronics Engineers) 1394, etc. These transmission interfaces can output signals and serve as finite electric current sources which provide either signals or rated electric currents for other electronic devices coupled thereto, for example, a hard disk drive (HDD), compact disc read-only memory (CD-ROM) and compact disc-recordable drive (CD-R) with the USB, PCMCIA or IEEE 1394.

Generally, when the personal computer or notebook is externally connected to a portable HDD, CD-ROM or CD-R via the output transmission interfaces of USB, PCMCIA and IEEE 1394, the personal computer or notebook usually acts as a server, while the portable HDD, CD-ROM or CD-R acts as a client.

In such a client-server architecture, usually due to the limitation on the rated electric current provided from the transmission interfaces, for example, 500 mA for USB interface, it makes the personal computer or notebook difficult to supply sufficient electric currents to the HDD, CD-ROM or CD-R which requires a relatively larger electric current for some operations to read or write data from or on the HDD or CD-R. As a result, the personal computer or notebook may be overloaded. Under this situation, a current protection circuit of the personal computer or the notebook is activated to terminate the output power from the USB, PCMCIA and IEEE 1394 interfaces. A conventional solution to this problem is the use of an additional and external power supplier to provide power for the eternally-connected portable HDD, CD-ROM or CD-R.

It is therefore greatly desired to obtain another approach to overcome the above problem and to provide sufficient power for the eternally-connected portable HDD, CD-ROM or CD-R without additional and external power supply.

### SUMMARY OF THE INVENTION

An objective of the present invention is to provide an apparatus and a method for electric current control applied between two electronic devices, whereby under a condition not using additional power supply, the electric current control apparatus can rectify, amplify and output an electric current from a finite current source, and provide this electric current for a portable electronic device which usually requires larger power for operation.

Another objective of the present invention is to provide an apparatus and a method for electric current control applied between two electronic devices, whereby under a condition not using additional power supply, the electric current control apparatus can regulate and filter a rated electric current from a finite current source, and output this rated electric current to a portable electronic device which usually requires larger power for operation.

In accordance with the above and other objectives, the present invention proposes an apparatus and a method for electric current control for being applied between at least two electronic devices, namely a first electronic device and a second electronic device which are connected to the electric current control apparatus. Under a condition not having additional power supply, the electric current control apparatus can rectify and amplify an electric current of a finite current source which is inputted from a transmission interface of the first electronic device to the electric current control apparatus, as well as regulate and filter a rated electric current from the finite current source. And, the electric current control apparatus transmits the rectified and amplified electric current and/or the processed rated electric current to the second electronic device for usage through a transmission interface of the second electronic device.

The electric current control apparatus includes a charger module. During the above electric-current processing performance, first, the electric current control apparatus charges up the charger module with the electric current of the finite current source from the transmission interface of the first electronic device. The charger module after being charged serves as a power source and provides an electric current which is combined with the electric current of the finite current source that is inputted to the electric current control apparatus from the transmission interface of the first electronic device. The electric current control apparatus then outputs the combined electric current to the second electronic device through the transmission interface of the second electronic device. Besides rectification and amplification of the electric current, the electric current control apparatus also regulates and filters the rated electric current of the finite current source from the first electronic device and outputs the processed rated electric current to the second electronic device for usage.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing a connection between an electric current control apparatus according to the invention and two electronic devices;

FIG. 2 is a flow diagram showing the procedural steps of an electric current control method in the use of the electric current control apparatus shown in FIG. 1;

FIG. 3 is a flow diagram showing the detailed procedures of a step of rectifying and amplifying an electric current for the electric current control method shown in FIG. 2;

FIG. 4 is a block diagram showing basic systemic architecture of the electric current control apparatus shown in FIG. 1;

FIG. 5 is a block diagram showing detailed systemic architecture of the electric current control apparatus shown in FIG. 4;

FIG. 6 is a circuit diagram showing an embodiment of circuit configuration of the electric current control apparatus shown in FIG. 4 and FIG. 5; and

FIG. 7 is a flow diagram showing the detailed procedures of a charging step for the electric current control method shown in FIG. 3.

### DETAILED DESCRIPTION OF THE PREFERRED EMBODIMENTS

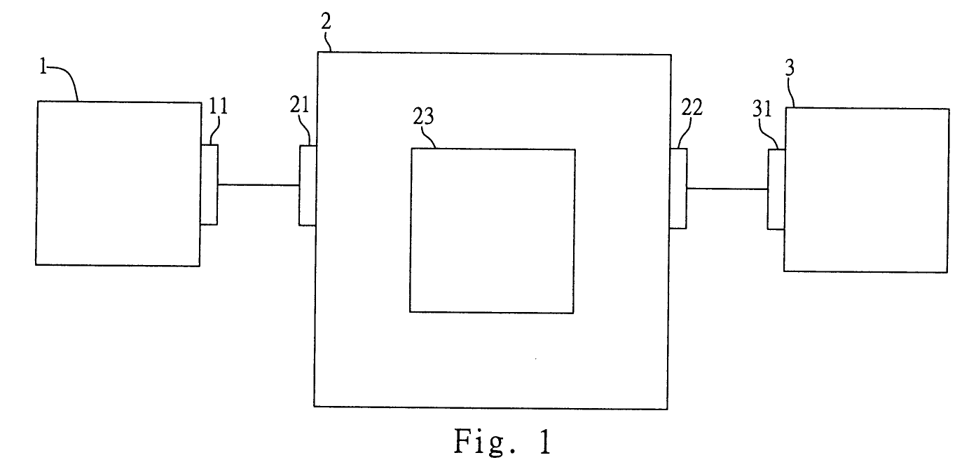

FIG. 1 illustrates a connection between an electric current control apparatus proposed by the present invention and two electronic devices. As shown in FIG. 1, the electric current control apparatus 2 is provided between a first electronic device 1 and a second electronic device 3, wherein a transmission interface 21 of the electric current control apparatus 2 is connected to a transmission interface 11 of the first electronic device 1, and another transmission interface 22 of the electric current control apparatus 2 is connected to a transmission interface 31 of the second electronic device 3. In this embodiment, the first electronic device 1 may be a personal computer or notebook; the second electronic device 3 may be a HDD, CD-ROM or CD-R; and the transmission interfaces 11, 21, 22 and 31 each may be a USB, PCMCIA or IEEE 1394 interface.

Under a condition not using additional power supply, the electric current control apparatus 2 can rectify and amplify an electric current from the transmission interface 11 of the first electronic device 1 through the transmission interface 21, and regulate and filter a rated electric current of a finite current source inputted through the transmission interfaces 11 and 21. The rectified and amplified electric current or the processed rated electric current can be transmitted from the electric current control apparatus 2 through the transmission interfaces 22 and 31 to the second electronic device 3 for usage.

The electric current control apparatus 2 includes a charger module 23. In the case of the electric current control apparatus 2 being a personal computer or notebook, the charger module 23 may consist of a charge circuit having a capacitor or rechargeable battery. The electric current control apparatus 2 charges up the charger module 23 by the electric current from the finite current source and inputted into the electric current control apparatus 2 through the transmission interface 11 of the first electronic device 1. The charger module 23 after being charged serves as a power source to provide an electric current which is combined with the electric current from the finite current source and through the transmission interface 11 of the first electronic device 1. The electric current control apparatus 2 can then output the combined electric current through the transmission interfaces 22 and 31 to the second electronic device 3 for usage. Besides the above current combination to provide the second electronic device 3 with a rectified and amplified electric current, the electric current control apparatus 2 can also supply a rated electric current from the finite current source and through the first electronic device 1 to the second electronic device 3. In this case, the electric current control apparatus 2 regulates and filters the rated electric current from the finite current source, and outputs the processed rated electric current through the transmission interfaces 22 and 31 to the second electronic device 3 for usage.

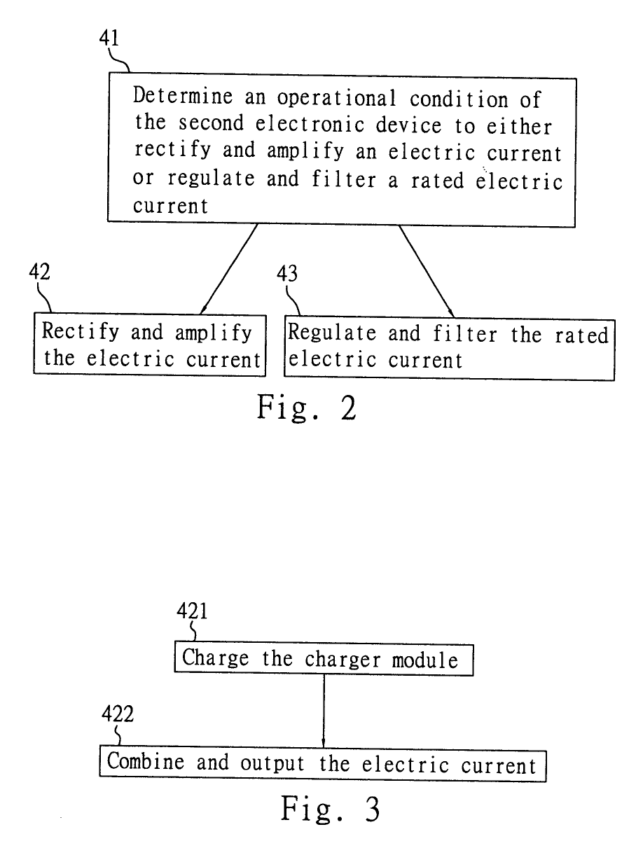

FIG. 2 illustrates the procedural steps of an electric current control method in the use of the electric current control apparatus 2 shown in FIG. 1. In this embodiment, the first electronic device 1 may be a personal computer or notebook; the second electronic device 3 may be a HDD, CD-ROM or CD-R; and the transmission interfaces 11, 21, 22 and 31 each may be a USB, PCMCIA or IEEE 1394 interface.

As shown in FIG. 2, in step 41, when the transmission interfaces 21 and 22 of the electric current control apparatus 2 are respectively in connection with the transmission interface 11 of the first electronic device 1 and the transmission interface 31 of the second electronic device 3, an operational condition of the second electronic device 3 is determined. If the second electronic device 3 requires a larger electric current to execute some operations for example to read or write data from or on a HDD or CD-R, it proceeds to step 42 where the electric current control apparatus 2 rectifies, amplifies and outputs an electric current from the finite current source. However, if the second electronic device 3 does not require a larger electric current, it proceeds to step 43 where the electric current control apparatus 2 regulates, filters and outputs a rated electric current from the input finite current source.

In step 42, the electric current control apparatus 2 rectifies and amplifies the electric current of the finite current source from the transmission interface 11 of the first electronic device 1, and provides the rectified and amplified electric current for the second electronic device 3 through the transmission interfaces 22 and 31.

In step 43, the electric current control apparatus 2 regulates and filters the rated electric current of the finite current source from the transmission interface 11 of the first electronic device 1, and provides the processed rated electric current of the finite current source for the second electronic device 3 through the transmission interfaces 22 and 31.

FIG. 3 illustrates the detailed procedures of the step 42 of rectifying and amplifying an electric current for the electric current control method shown in FIG. 2. As shown in FIG. 3, first in step 421, the electric current control apparatus 2 charges up the charger module 23 with the electric current of the finite current source from the transmission interface 11 of the first electronic device 1. Then, it proceeds to step 422.

In step 422, the charger module 23 after being charged serves as a power source and provides an electric current which would be combined with the electric current of the finite current source that is inputted to the electric current control apparatus 2 from the transmission interface 11 of the first electronic device 1. The combined electric current is outputted from the electric current control apparatus 2 through the transmission interfaces 22 and 31 to the second electronic device 3 for usage. Thereby, the combined or amplified electric current provided for the second electronic device 3 allows the second electronic device 3 to perform some operations requiring a large electric current at certain time instants or intervals.

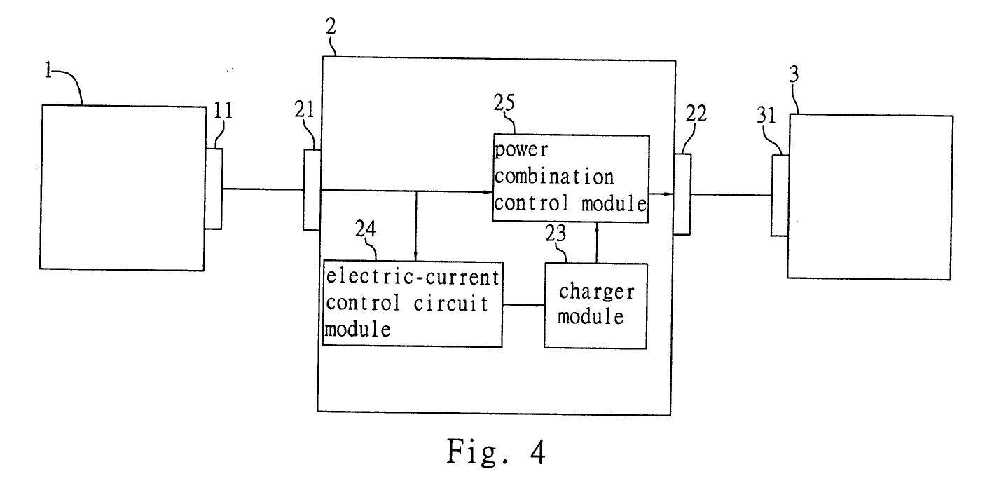

FIG. 4 illustrates basic systemic architecture of the electric current control apparatus shown in FIG. 1. In this embodiment, the first electronic device 1 may be a personal computer or notebook; the second electronic device 3 may be a HDD, CD-ROM or CD-R; and the transmission interfaces 11, 21, 22 and 31 each may be a USB, PCMCIA or IEEE 1394 interface.

As shown in FIG. 4, the electric current control apparatus 2 is provided between the first electronic device 1 and the second electronic device 3, wherein the transmission interface 21 of the electric current control apparatus 2 is connected to the transmission interface 11 of the first electronic device 1, and the transmission interface 22 of the electric current control apparatus 2 is connected to the transmission interface 31 of the second electronic device 3. Under the condition not having additional power supply, the electric current control apparatus 2 can rectify, amplify and output the electric current of a current source inputted thereto.

The electric current control apparatus 2 includes the charger module 23, an electric-current control circuit module 24, and a power combination control module 25. The charger module 23 is charged by an electric current from the electric-current control circuit module 24. After being charged, the charger module 23 serves as a power source and also regulates and filters an electric current of the finite current source inputted into the electric current control apparatus 2. The electric-current control circuit module 24 is used to control and monitor an electric current of the finite current source from the transmission interface 11 of the first electronic device 1 and to charge up the charger module 23. When the charger module 23 is charged up to a predetermined voltage such as 4.8 volts, the electric-current control circuit module 24 then actuates a combination switch 251 of the power combination control module 25 which thereby combines an electric current from the charger module 23 and the electric current of the finite current source from the transmission interface 11 of the first electronic device 1, and the combined electric current is transmitted through the transmission interfaces 22 and 31 to the second electronic device 3 for usage.

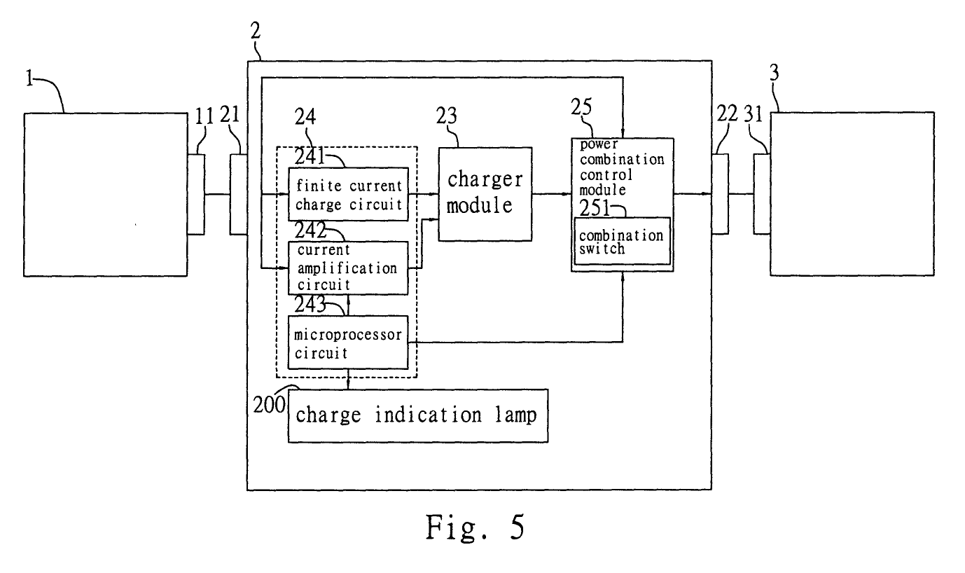

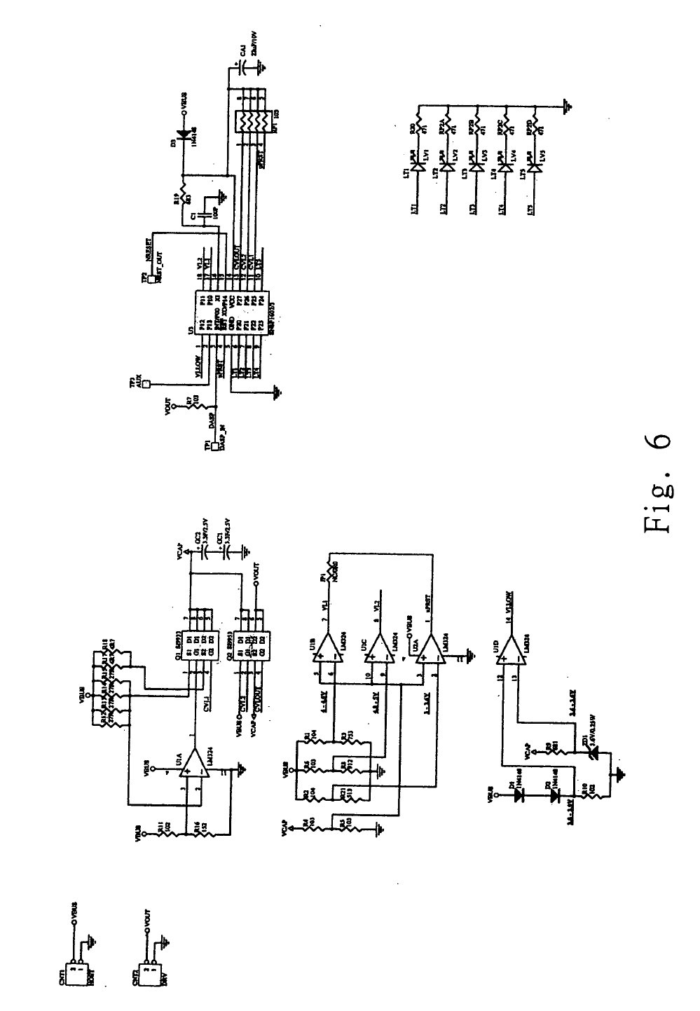

FIG. 5 illustrates detailed systemic architecture of the electric current control apparatus shown in FIG. 4. As shown in FIG. 5, the electric-current control circuit module 24 includes a finite current charge circuit 241, a current amplification circuit 242, and a microprocessor circuit 243.

The finite current charge circuit 241 receives an electric current of the finite current source from the transmission interface 11 of the first electronic device 1 to charge up the charger module 23 with this electric current. When the charger module 23 is charged up to a predetermined voltage such as 4 volts, the finite current charge circuit 241 would decrease the electric current for charging the charger module 23 to be below a certain level e.g. under 100 mA. At this time, the current amplification circuit 242 would provide a specific current such as 300 mA to keep charging the charger module 23. The microprocessor circuit 243 controls and monitors the finite current charge circuit 241 and the current amplification circuit 242 to determine how to charge up the charger module 23 with a constant electric current, and transmits a signal to a charge indication lamp 200 to indicate the charging progress. When the charger module 23 is charged up to a predetermined voltage such as 4.8 volts, the combination switch 251 of the power combination control module 25 is actuated to allow the power combination control module 25 to combine the electric current of the finite current source from the transmission interface 11 of the first electronic device 1 and the electric current from the charger module 23 after being charged, and the combined electric current is transmitted through the transmission interfaces 22 and 31 to the second electronic device 3 for usage.

FIG. 6 illustrates an embodiment of circuit configuration of the electric current control apparatus shown in FIG. 4 and FIG. 5. As shown in FIG. 6, circuit CNT1 is the transmission interface 11 of the first electronic device 1; circuit CNT2 is the transmission interface 31 of the second electronic device 3; circuits UIA and Q1-1 form the finite current charge circuit 241; circuit Q1-2 is the current amplification circuit 242; circuits U3, U1B, 1C, 1D and U2A form the microprocessor circuit 243; circuit LT1-LT5 is the charge indication lamp 200; circuits GC1 and GC2 form the charger module 23; and circuits Q2-1 and Q2-2 form the power combination control module 25.

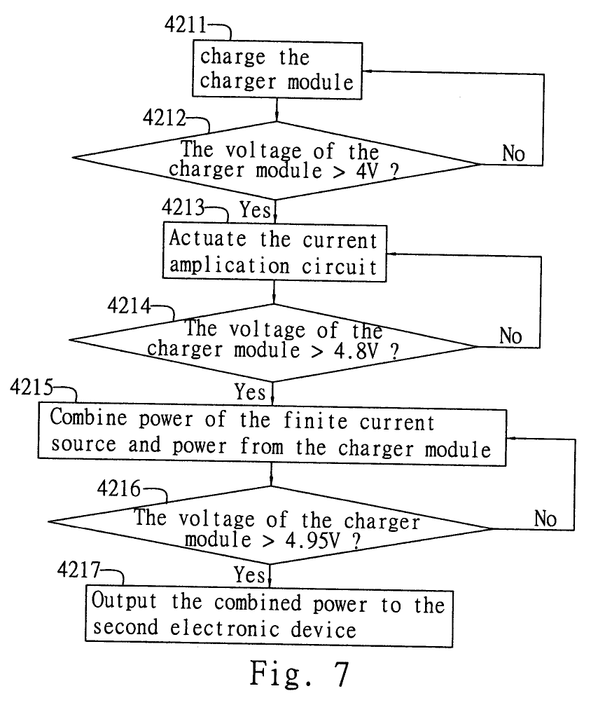

FIG. 7 illustrates the detailed procedures of the charging step 421 for the electric current control method shown in FIG. 3. As shown in FIG. 7, in step 4211, a charging process is initiated. When the voltage of the charger module 23 is reduced to 2.5 volts, the microprocessor circuit 243 is actuated, and the finite current charge circuit 241 is self-activated upon the presence of electric current and receives the electric current of limited current from the transmission interface 11 of the first electronic device 1. For example, the finite current charge circuit 241 charges up the charger module 23 with a constant electric current such as 350 mA from the USB interface. Then, it proceeds to step 4212.

In step 4212, it determines whether the voltage of the charger module 23 is greater than 4 volts or not. If the voltage of the charger module 23 is smaller than 4 volts, it returns to step 4211 and keeps charging the charger module 23. If the voltage of the charger module 23 is larger than 4 volts, it proceeds to step 4213.

In step 4213, the current amplification circuit 242 is actuated. When the finite current charge circuit 241 charges the charger module 23 up to 4 volts, the charging current would be decreased to 100 mA below. At this time, the current amplification circuit 242 provides a larger electric current to supplement the charging current up to 300 mA and thus keeps charging the charger module 23. Then, it proceeds to step 4214.

In step 4214, it determines whether the voltage of the charger module 23 is greater than 4.8 volts or not. If the voltage of the charger module 23 is smaller than 4.8 volts, it returns to step 4213 and keeps charging the charger module 23. If the voltage of the charger module 23 is larger than 4.8 volts, it proceeds to step 4215.

In step 4215, when the charger module 23 is charged up to 4.8 volts, the combination switch 251 of the power combination control module 25 is actuated to combine the electric power of the finite current source from the transmission interface 11 of the first electronic device 1 and the electric power from the charger module 23 for power or voltage regulation. Then, it proceeds to step 4216.

In step 4216, it determines whether the combined and regulated voltage of the power of the finite current source and the power from the charger module 23 is greater than 4.95 volts or not. If the voltage is smaller than 4.95 volts, it returns to step 4215. If the voltage is larger than 4.95 volts, it proceeds to step 4217.

In step 4217, the combined power is transmitted from the combination switch 251 of the power combination control module 25 through the transmission interfaces 22 and 31 to the second electronic device 3 for usage.

The above electric current control apparatus and method yield significant benefits. The electric current control apparatus is provided between and connected to two electronic devices; under a condition not having additional power supply, the electric current control apparatus can rectify, amplify and output an electric current which is inputted to the electric current control apparatus from a finite current source through one of the electronic devices, so as to provide the rectified and amplified electric current for the other electronic device which may be portable and requires a larger power for performing particular operations. Moreover, the electric current control apparatus can also regulate and filter a rated electric current from the finite current source, and output the processed rated electric current to the portable electronic device for usage. Therefore, the electric current control apparatus performs the rectification and amplification of the electric current as well as the regulation and filtering of the rated electric current from the finite current source to supply sufficient power to an electronic device which may be portable and usually requires a larger electric current for operation.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An electric current control method for use in an electric current control apparatus connected with at least a first electronic device and a second electronic device, to allow the electric current control apparatus to rectify, amplify and output an electric current from a current source under a condition free of additional power supply, the electric current control method comprising the steps of:
(1) having the electric current control apparatus rectify and amplify electric power of a finite current source that is inputted from a transmission interface of the first electronic device to the electric current control apparatus; and
(2) having the electric current control apparatus transmit the rectified and amplified electric power to the second electronic device through a transmission interface of the second electronic device.

2. The electric current control method of claim 1, wherein the step (1) comprises the procedures of:
(1-1) having the electric current control apparatus charge up a charger module thereof with the electric current of the finite current source from the transmission interface of the first electronic device; and
(1-2) having the electric current control apparatus combine an electric current from the charger module and the electric current of the finite current source from the transmission interface of the first electronic device, and transmit the combined electric current to the second electronic device through the transmission interface of the second electronic device.

3. The electric current control method of claim 1, wherein the electric current control apparatus is allowed to regulate and filter a rated electric current of the finite current source from the transmission interface of the first electronic device, and transmit the processed rated electric current to the second electronic device through the transmission interface of the second electronic device.

4. The electric current control method of claim 1, wherein the step (1) comprises the procedures of:
(1-1) amplifying the electric power from the transmission interface of the first electronic device to have a first stage of voltage;
(1-2) amplifying the first stage of voltage to reach a second stage of voltage; and
(1-3) amplifying the second stage of voltage to reach a third stage of voltage.

5. The electric current control method of claim 4, wherein the first stage of voltage is 4 volts.

6. The electric current control method of claim 4, wherein the second stage of voltage is 4.8 volts.

7. The electric current control method of claim 4, wherein the third stage of voltage is 4.95 volts.

8. The electric current control method of claim 1, wherein the transmission interface of the first electronic device is selected from the group consisting of a USB interface, PCMCIA interface, and IEEE 1394 interface.

9. The electric current control method of claim 1, wherein the first electronic device is selected from the group consisting of a notebook computer and personal computer.

10. The electric current control method of claim 1, wherein the transmission interface of the second electronic device is selected from the group consisting of a USB interface, PCMCIA interface, and IEEE 1394 interface.

11. The electric current control method of claim 1, wherein the second electronic device is selected from the group consisting of a HDD, CD-ROM, and CD-R.

12. An electric current control apparatus connected with at least a first electronic device and a second electronic device, to rectify, amplify and output an electric current from a current source under a condition free of additional power supply, the electric current control apparatus comprising:
a charger module charged by an electric current of a finite current source that is inputted to the electric current control apparatus from a transmission interface of the first electronic device, wherein the charger module after being charged serves as a power source to provide an electric current which is combined with the electric current of the finite current source inputted to the electric current control apparatus, to allow the combined electric current to be transmitted to the second electronic device through a transmission interface of the second electronic device.

13. The electric current control apparatus of claim 12, further comprising:
an electric-current control circuit module for controlling and monitoring the electric current of the finite current source from the transmission interface of the first electronic device and for charging up the charger module; and
a power combination control module having a combination switch and actuated by the electric-current control circuit module to combine the electric current of the finite current source from the first electronic device and the electric current from the charger module when the charger module is charged to have a predetermined voltage, so as to allow the combined electric current to be transmitted to the second electronic device.

14. The electric current control apparatus of claim 13, wherein the electric-current control circuit module comprises:
a finite current charge circuit for receiving the electric current of the finite current source from the transmission interface of the first electronic device to charge the charger module with the received electric current;
a current amplification circuit for providing a supplementary current to the charging electric current, wherein when the charger module is charged to have a first predetermined voltage, the charging electric current from the finite current charge circuit is decreased to be below a first predetermined current value, and the current amplification circuit provides the supplementary current of a second predetermined current value to keep charging the charger module; and
a microprocessor circuit for controlling and monitoring the finite current charge circuit and the current amplification circuit to determine a process for charging the charger module with a constant electric current, wherein when the charger module is charged to have a second predetermined voltage, the combination switch of the power combination control module is actuated to allow the power combination control module to combine the electric current of the finite current source from the first electronic device and the electric current from the charger module and transmit the combined electric current to the second electronic device.

15. The electric current control apparatus of claim 14, wherein the first predetermined voltage is 4 volts, the first predetermined current value is 100 mA, the second predetermined voltage is 4.8 volts, and the second predetermined current value is 300 mA.

16. The electric current control apparatus of claim 12, wherein the charger module is allowed to regulate and filter the electric current of the finite current source inputted into the electric current control apparatus.

17. The electric current control apparatus of claim 12, wherein the transmission interface of the first electronic device is selected from the group consisting of a USB interface, PCMCIA interface, and IEEE 1394 interface.

18. The electric current control apparatus of claim 12, wherein the first electronic device is selected from the group consisting of a notebook computer and personal computer.

19. The electric current control apparatus of claim 12, wherein the transmission interface of the second electronic device is selected from the group consisting of a USB interface, PCMCIA interface, and IEEE 1394 interface.

20. The electric current control apparatus of claim 12, wherein the second electronic device is selected from the group consisting of a HDD, CD-ROM, and CD-R.
